(19) United States
(12) Patent Application Publication
(10) Pub. No.: US 2009/0129808 A1
(43) Pub. Date: May 21, 2009

(54) IMAGE FORMING APPARATUS, AND CONTROL METHOD THEREOF

(75) Inventor: Chikashi Kamei, Shibuya-ku (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/942,073

(22) Filed: Nov. 19, 2007

(51) Int. Cl. G03G 15/00

(52) U.S. Cl. 399/88

(57) ABSTRACT

An image forming apparatus of the invention includes, in the image forming apparatus having a normal operation mode and plural power saving modes, a control unit to decide between the normal operation mode and the plural power saving modes, and plural switching power sources that can independently change switching frequencies according to the power saving mode instructed from the control unit.

### BACKGROUND OF THE INVENTION

1. Field of the Invention

The present invention relates to an image forming apparatus and a control method thereof, and particularly to an image forming apparatus having a power source which supports a power saving mode, and a control method thereof.

2. Related Art

Nowadays, approaches to the global warming issue are taken in various fields. Also in the field of an OA equipment used in an office or a home, various technical developments have been made from the viewpoint of power saving.

In order to promote the power saving of the OA equipment, the international activity called “Energy Star Program” becomes widespread. In the “Energy Star Program”, power saving standards of OA equipments are determined, and the display of “International Energy Star Logo” is permitted to a product which satisfies the standards.

Also in the field of an image forming apparatus such as a copier or an MFP (Multi-Function Peripheral), plural power saving modes called “standby mode” or “sleep mode” are provided to achieve the power saving. In the case where a user's operation is not performed for a given time, a mode is automatically successively shifted to these power saving modes through multiple stages, and the power source of a functional structure unit unnecessary in each of the modes is turned off according to the kind of the power saving mode, so that wasteful power consumption is eliminated.

On the other hand, also in a power source device used for an image forming apparatus, a contrivance such as improving power supply efficiency has been made. For example, JP-A 2002-315326 discloses a technique in which a change in load power is detected by a simple structure, and when the load is low, the switching frequency of a switching power source is reduced, so that the power conversion efficiency of the power source device is improved.

However, the technique disclosed in JP-A2002-315326 is such that the reduction of the load of the power source is detected based on two operation states of on and off of a cooling fan, and the switching frequency is changed in two stages. Thus, as the power source of a recent image forming apparatus having various power saving modes, a sufficient power saving effect can not be necessarily expected.

### SUMMARY OF THE INVENTION

The present invention is made in view of the above circumstances, and has an object to provide an image forming apparatus having plural power saving modes and including a power source device to perform power source conversion according to each of the power saving modes at high efficiency, and a control method thereof.

In order to achieve the above object, according to an aspect of the invention, in an image forming apparatus having a normal operation mode and plural power saving modes, the image forming apparatus includes a control unit configured to decide between the normal operation mode and the plural power saving modes, and plural switching power sources that can independently change switching frequencies according to the power saving mode instructed from the control unit.

Besides, in order to achieve the above object, according to another aspect of the invention, in a control method of an image forming apparatus having a normal operation mode and plural power saving modes, the control method of the image forming apparatus includes the steps of (a) deciding between the normal operation mode and the plural power saving modes, and (b) independently changing switching frequencies of plural switching power sources according to the decided power saving mode.

### BRIEF DESCRIPTION OF THE DRAWINGS

In the accompanying drawings:

FIG. 1 is a view showing a structural example of an image forming apparatus according to an embodiment of the invention;

FIG. 2 is a view showing a structural example of a power source unit included in the image forming apparatus according to the embodiment of the invention; and

FIGS. 3A to 3C are views schematically showing a relation among a power saving mode, a switching frequency and a power consumption seen from the primary side of a power source unit.

### DETAILED DESCRIPTION OF THE PREFERRED EMBODIMENTS

An embodiment of an image forming apparatus of the invention, and a control method thereof will be described with reference to the accompanying drawings.

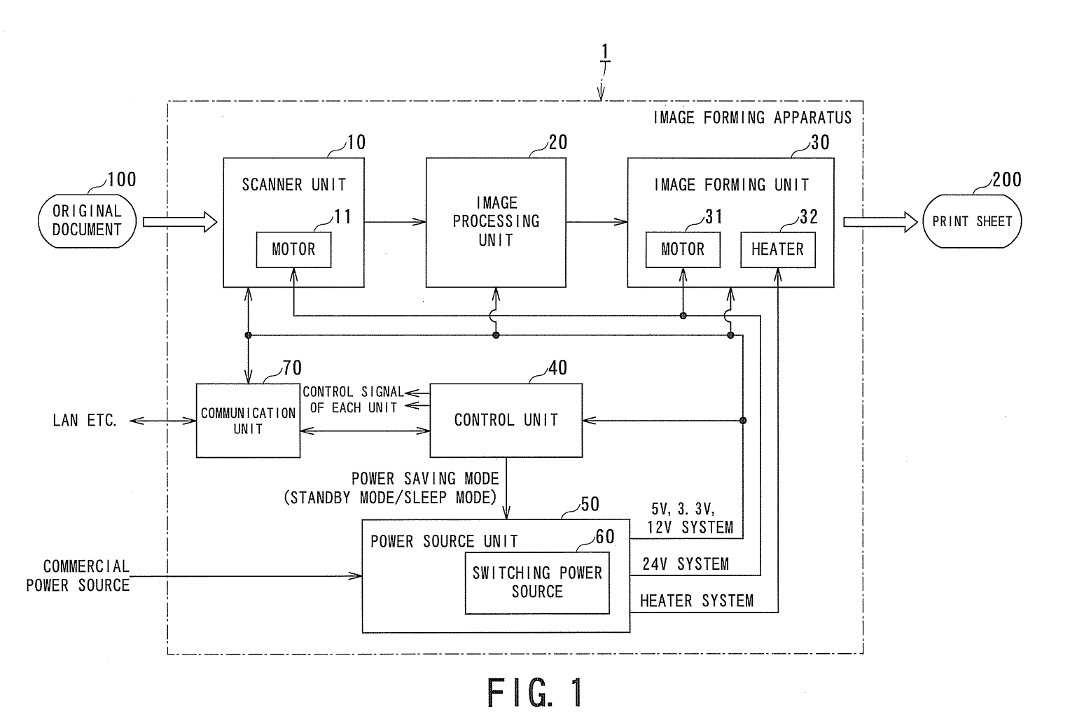

FIG. 1 is a view showing a structural example of an image forming apparatus 1 according to an embodiment of the invention. The image forming apparatus 1 includes a scanner unit 10, an image processing unit 20, an image forming unit 30, a control unit 40, a power source unit 50 including a switching power source 60, and a communication unit 70.

The scanner unit 10 includes a light source and a CCD sensor (neither are shown), and at the time of printing, the light source is driven by a motor 11, and light is continuously irradiated to an original document 100 from one end thereof to the other end. The reflected light from the original document is successively converted into an electric signal by the CCD sensor. The electric signal is AD converted into image data.

The image processing unit 20 performs various image processes, such as a filtering process, on the image data outputted from the scanner unit 10. In the case where color printing is performed, a color conversion process is performed in the image processing unit 20. The image processing unit 20 includes various digital processing circuits and electric circuits such as a processor.

The image forming unit 30 prints the image data outputted from the image processing unit 20 on a sheet by, for example, an electrophotographic system. In the electrophotographic system, laser light corresponding to the intensity of the image data is generated, and an electrostatic latent image is formed on a photoconductive drum (not shown) rotated and driven by a motor 31. The electrostatic latent image of the photoconductive drum is developed with toner and becomes a developed image. After the developed image is transferred to a recording sheet transported by driving of the motor 31, the toner is heated and fixed to the recording sheet by a heater 32, and the print sheet 200 on which the toner is fixed is finally discharged to the outside. This discharge is also performed by the driving of the motor 31. Although FIG. 1 exemplifies only one motor 31, the rotation of the photoconductive drum, the transportation of the recording sheet, and the discharge of the print sheet may be performed by plural different motors.

The control unit 40 includes a CPU and the like, and controls the whole image forming apparatus 1. The control unit 40 decides between various operation modes including power saving modes, and distributes control signals corresponding to the operation mode to the respective units.

The operation modes include the power saving mode called a “standby mode” and a “sleep mode”, in addition to a “print mode” (normal operation mode).

In the print mode, the motor 11 to drive the light source, the motor 31 to drive the photoconductive drum and the transport mechanism of the sheet, the heater 32 for fixing, and the like are operated in addition to almost all electric circuits including the CPU. The print mode is the operation mode in which the load on the power source becomes largest.

The standby mode is the operation mode of the standby state in which printing can be performed at any time. Although the operation of the electric circuit is almost equal to that in the print mode, since printing is not actually performed, it is not necessary to operate the motors 11 and 31 and the heater 32. Thus, in the standby mode, a motor clutch (not shown) of the motor 11 is turned off, and the heater 32 is turned off, so that the load on the power source is made significantly smaller than that in the print mode. When a print instruction is inputted from the control panel or an external personal computer at the time of the standby mode, a shift is immediately made to the print mode and printing is performed.

The sleep mode is the operation mode to which the standby mode is automatically shifted when it continues for a specified time, and is the operation mode in which the load on the power source is lowest. Specifically, except for the functional structure unit (communication unit 70) to perform communication with the outside and the control panel, power supply to all electric circuits including the CPU is stopped.

In the case where the print instruction is issued through the LAN from the personal computer connected to the outside, or the user operates the control panel, these signals can be recognized in the communication unit 70 to which power is supplied. Thereafter, the power supply to the electric circuits including the CPU is instructed from the communication unit 70, a return is made to the standby mode, and further, a shift is made to the print mode.

The power source unit 50 inputs the commercial power source, and converts it into power sources of respective systems such as a circuit system power source (5 V, 3.3 V, ±12 V system) to mainly supply power to the electric circuits of the respective units, a 24V system power source to mainly supply power to the motor, and a heater system power source to mainly supply power to the heater 32.

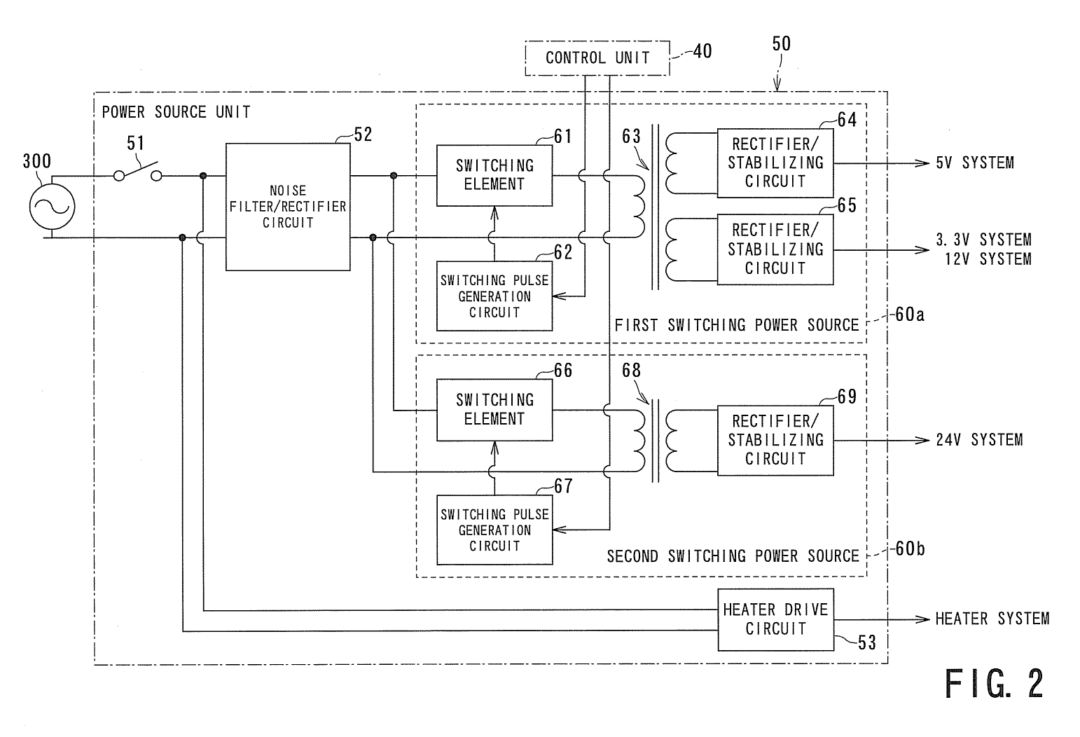

FIG. 2 is a view showing the more detailed structural example of the power source unit 50. The power source unit 50 includes a main power source switch 51, a noise filer/rectifier circuit 52, a first switching power source 60a, a second switching power source 60b, a heater drive circuit 53 and the like.

The first switching power source 60a includes a switching element 61, a switching pulse generation circuit 62, a transformer 63, rectifier/stabilizing circuits 64 and 65, and the like. Similarly, the second switching power source 60b includes a switching element 66, a switching pulse generation circuit 67, a transformer 68, a rectifier/stabilizing circuit 69 and the like.

The main power source switch 51 is the switch to turn on and off the power source of the whole image forming apparatus 1. A commercial power source 300 inputted to the power source unit 50 is inputted to the noise filter/rectifier circuit 52 through the main power source switch 51.

In the noise filter/rectifier circuit 52, disturbance noises and the like are filtered, and the AC commercial power source is rectified and is converted into a suitable DC voltage. The output of the noise filter/rectifier circuit 52 is inputted to the first switching power source 60a and the second switching power source 60b, and is converted into DC voltages suitable for the electric circuits or electric parts of the respective units of the image forming apparatus 1. A power source for heater is separately supplied from the heater drive circuit 53 to the heater 32 used for fixing of toner.

The switching element 61 of the first switching power source 60a is the element including, for example, an FET (Field-Effect Transistor). The switching element 61 is turned on and off according to the frequency (switching frequency) of the switching pulse generated by the switching pulse generation circuit 62, and converts the DC output of the noise filter/rectifier circuit 52 into a pulse-like AC power source. The voltage of the pulse-like AC power source is converted into a desired voltage by the transformer 63. Then, the pulse-like AC power source is converted into a stable DC power source by the rectifier/stabilizing circuits 64 and 65, and the stable DC power source is supplied to the electric circuits and electric parts of the respective units in the image forming apparatus 1.

In the example of this embodiment, the first switching power source 60a converts the DC power source outputted from the noise filer/rectifier circuit 52 into respective voltages of a 5V system, a 3.3V system and ±12V system. The respective voltages are suitable for the electric parts of the digital circuits and analog circuits in the respective units in the image forming apparatus 1.

The switching element 66 of the second switching power source 60b also includes an FET, is turned on and off according to the switching frequency of the switching pulse generated by the switching pulse generation circuit 67, and converts the DC output of the noise filter/rectifier circuit 52 into a pulse-like AC power source. The pulse-like AC power source is converted into a desired voltage by the transformer 68. The pulse-like AC power source converted into the desired voltage is converted into a stable DC power source of about 24V by the rectifier/stabilizing circuit 69, and is supplied to each of the motors 11 and 31 in the image forming apparatus 1 and a partial analog electric circuit.

In general, in this kind of switching power source including a transformer, as the switching frequency becomes high, a component such as a transformer can be miniaturized. Accordingly, from the viewpoint of miniaturization, the higher the switching frequency is, the more advantageous.

On the other hand, when the switching frequency is made high, the loss of a switching element such as an FET and its peripheral circuit becomes generally high, and the power conversion efficiency becomes low. That is, when it is assumed that the load power at the secondary side of the transformer is the same, as the switching frequency becomes high, the power consumption seen from the primary side becomes large. On the other hand, as the switching frequency becomes low, the loss of the switching element becomes small, and the power consumption seen from the primary side becomes small. Accordingly, from the viewpoint of power saving, the lower the switching frequency is, the more advantageous.

However, in the case where the switching frequency is made low, it is necessary to consider the magnetic saturation phenomenon of the transformer. In general, when the switching frequency is reduced, the magnetic saturation of the transformer occurs at a certain point, and as a result, there is a case where a very large current flows and the switching element is broken. The magnetic saturation of the transformer depends on the magnitude of the load power at the secondary side, and as the load power becomes large, the magnetic saturation becomes liable to occur.

In general, the maximum load power at the secondary side at the time of the normal operation is estimated, the switching frequency is set to be low within the range in which the magnetic saturation does not occur even in the state of the maximum load, and the balance between the stability of the operation (prevention of the magnetic saturation) and the power saving is taken.

Incidentally, like the image forming apparatus 1 of this embodiment, the recent image forming apparatus 1 includes plural power saving modes. The load power in each of the power saving modes can be estimated previously. Thus, according to the load power of each of the power saving modes, the switching frequency can be set to be a frequency lower than that at the normal operation within the range in which the magnetic saturation does not occur.

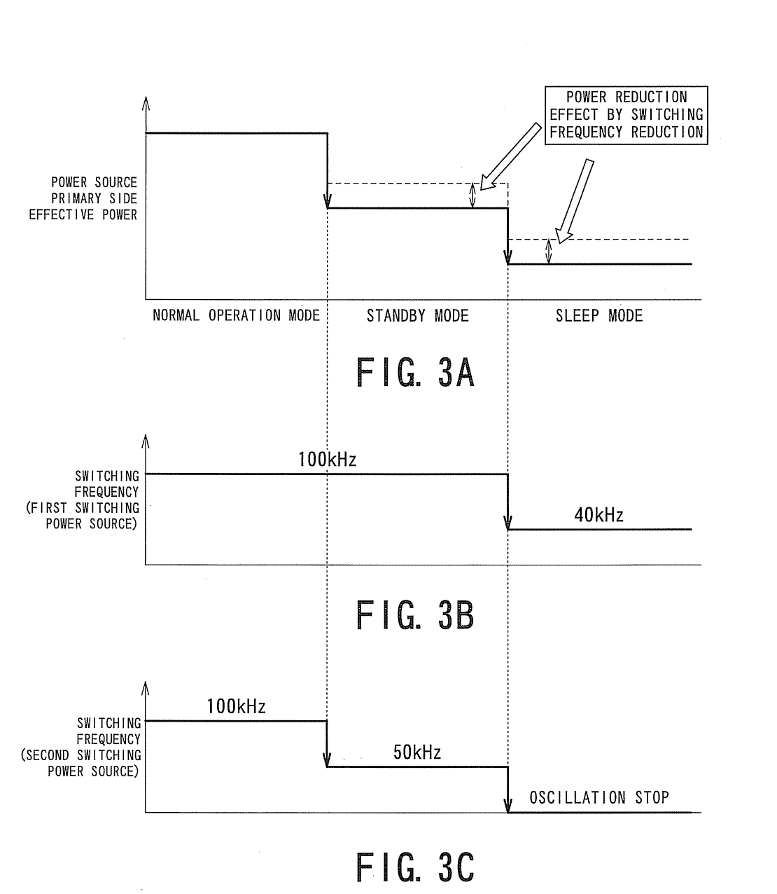

FIGS. 3A to 3C are views schematically showing an example of a relation among a power saving mode in the image forming apparatus 1 of the embodiment, a switching frequency and a power consumption. The horizontal axis of FIGS. 3A to 3C indicates the operation mode of the image forming apparatus 1, and as described before, the normal operation mode (print mode) and two power saving modes (standby mode and sleep mode) are included.

In FIGS. 3A to 3C, FIG. 3B is a view showing a relation between the switching frequency of the first switching power source 60a and the operation mode, and FIG. 3C is a view showing a relation between the switching frequency of the second switching power source 60b and the operation mode.

Besides, FIG. 3A is a view showing a relation between the effective power (that is, power consumption) seen from the input side of the power source unit 51 (that is, seen from the primary sides of the transformers 63 and 68) and the operation mode.

The normal operation mode is the operation mode at the time of printing, and is a state in which all digital circuits and analog circuits (circuits using the circuit power source) of the respective units are operated, and the motors 11 and 31 (electric parts using the 24V system power source) of the scanner unit 10 and the image forming unit 30 are also operated. Accordingly, in the normal operation mode, as shown in FIGS. 3B and 3C, both the switching frequency of the switching power source 60a to output the circuit power source and that of the switching power source 60b to output the 24V system power source are set to the normal switching frequency, for example, 100 kHz.

When printing is ended and a shift is made to the standby mode, the motors 11 and 31 are stopped, and the load power of the second switching power source 60b becomes small. This is because most of the 24V system as the output of the second switching power source 60b is used for the motors 11 and 31, although small part thereof is used for the analog circuit.

When the load power of the second switching power source 60b is reduced, the power consumption at the primary side thereof is also naturally reduced. A broken line of the standby mode of FIG. 3A shows the power consumption at the primary side in the case where the switching frequency of the second switching power source 60b is fixed to 100 kHz.

Actually, in the image forming apparatus 1 of this embodiment, as shown in FIG. 3C, the switching frequency of the second switching power source 60b is reduced from 100 kHz to, for example, 50 kHz. This is because, in the standby mode, since the load power of the 24V system is reduced, even if the switching frequency is reduced from that at the normal operation time, the magnetic saturation of the transformation 68 does not occur. The loss due to the switching element or the like is reduced by reducing the switching frequency, and as indicated by a solid line in FIG. 3A, the power consumption at the primary side becomes small, and the power saving effect becomes high.

The reduction of the switching frequency can be realized by a well-known technique. For example, in the switching pulse generation circuit 67, when a capacitor (not shown) to determine the oscillation frequency of the switching pulse is changed from a small capacitance capacitor to a large capacitance capacitor, the switching frequency can be reduced.

When the standby mode is further shifted to the sleep mode, except for the functional structure unit to perform communication with the outside, all circuits of digital circuits and analog circuits including the CPU are shut down. Thus, in the sleep mode, the load power of the 24V system of the second switching power source 60b becomes substantially zero, and the load power of the first switching power source 60a is also much reduced.

Then, in the sleep mode of the image forming apparatus 1 of this embodiment, the switching operation of the second switching power source 60b is stopped (switching frequency is set to zero), and the output of the second switching operation 60b is substantially turned off, whereas the switching frequency of the first switching power source 60a is reduced from 100 kHz at the time of the normal operation to, for example, 40 kHz.

Since the load power of the first switching power source 60a is much reduced in the sleep mode, the switching frequency at which the transformer 63 does not cause the magnetic saturation is also reduced. As in this embodiment, for example, even if the switching frequency is reduced to 40 kHz, the magnetic saturation does not occur. On the other hand, the loss of the switching element 61 or the like is reduced by reducing the switching frequency. Thus, as compared with the primary side power consumption in the case where the switching frequency is made 100 kHz equal to that in the normal operation mode, the power consumption becomes small, and the power saving effect is obtained. A difference between the broken line and the solid line shown in FIG. 3A schematically indicates the power saving effect.

For example, in the case where the power consumption in the sleep mode at the time when the switching frequency of the first switching power source 60a is 100 kHz is about 16 W, when the switching frequency is reduced to 40 kHz, the power reduction effect of about 5% or more is obtained. As a result, the power consumption in the sleep mode can be reduced to about 15 W or less.

As one of the standards determined by the energy star program described before, there is a power consumption regulation for a sleep mode. According to the regulation, for example, it is stated that the power consumption in the sleep mode of a copier in which the number of prints per minute is from 20 to 40 is 15 W or less.

In the image forming apparatus 1 of the embodiment, the power saving is realized by reducing the switching frequency, and it becomes possible to meet the regulations of the energy star program without reducing conventional functions in the sleep mode and the circuit structure.

In the description to this point, although the two power saving modes of the standby mode and the sleep mode have been described, even in the case where a larger number of more delicate power saving modes are included, the embodiment can be applied.

For example, in the case where the load power of one switching power source is changed in multiple stages according to the power saving modes, the switching frequency may be changed in multiple stages.

As described above, according to the image forming apparatus 1 of the embodiment and the control method thereof, in the image forming apparatus 1 having plural power saving modes, the power source conversion according to each of the power saving modes can be performed at high efficiency.

Incidentally, the present invention is not limited to the embodiment described above, but can be embodied at the practical phase by modifying the components within the scope not departing from the gist. Besides, various embodiments of the invention can be formed by suitable combinations of plural components disclosed in the embodiment. For example, some components may be deleted from all components described in the embodiment. Further, components in different embodiments may be suitably combined.

What is claimed is:

1. An image forming apparatus having a normal operation mode and plural power saving modes, the image forming apparatus comprising:
a control unit configured to decide between the normal operation mode and the plural power saving modes; and
plural switching power sources that can independently change switching frequencies according to the power saving mode instructed from the control unit.

2. The image forming apparatus according to claim 1, wherein the switching power source changes the switching frequency to a switching frequency lower than that in the normal operation mode according to the power saving mode.

3. The image forming apparatus according to claim 1, wherein the switching power source can change the switching frequency to a switching frequency lower than that in the normal operation mode according to the power saving mode, and can further turn off its output.

4. The image forming apparatus according to claim 2, wherein the switching power source includes a transformer to convert a switched signal into one or plural kinds of voltages, and
the switching frequency lower than that in the normal operation mode is the switching frequency reduced to an extent that the transformer does not cause magnetic saturation.

5. The image forming apparatus according to claim 3, wherein the switching power source includes a transformer to convert a switched signal into one or plural kinds of voltages, and
the switching frequency lower than that in the normal operation mode is the switching frequency reduced to an extent that the transformer does not cause magnetic saturation.

6. The image forming apparatus according to claim 3, wherein the plural power saving modes include a standby mode in which power necessary at a time of printing is reduced by turning off a motor clutch, and a sleep mode in which all power is turned off except for power necessary for communication with outside,
the plural switching power sources include a first switching power source and a second switching power source,
in the standby mode, the first switching power source keeps the switching frequency in the normal operation mode, whereas the second switching power source makes a change to a switching frequency lower than the switching frequency in the normal operation mode, and
in the sleep mode, the first switching power source makes a change to a switching frequency lower than the switching frequency in the normal operation mode, and the second switching power source turns off its output.

7. The image forming apparatus according to claim 6, wherein the first switching power source is the power source to supply power to be supplied to the control unit and the power necessary for communication with the outside, and
the second switching power source is the power source to supply power of the motor clutch to drive each unit at the time of printing.

8. A control method of an image forming apparatus having a normal operation mode and plural power saving modes, the control method of the image forming apparatus, comprising the steps of:
(a) deciding between the normal operation mode and the plural power saving modes; and
(b) independently changing switching frequencies of plural switching power sources according to the decided power saving mode.

9. The control method of the image forming apparatus according to claim 8, wherein at the step (b), the switching frequency is changed to a switching frequency lower than that in the normal operation mode according to the power saving mode.

10. The control method of the image forming apparatus according to claim 8, wherein at the step (b), the switching frequency is changed to a switching frequency lower than that in the normal operation mode according to the power saving mode, and its output is turned off.

11. The control method of the image forming apparatus according to claim 9, wherein the switching power source includes a transformer to convert a switched signal into one or plural kinds of voltages, and
the switching frequency lower than that in the normal operation mode is the switching frequency reduced to an extent that the transformer does not cause magnetic saturation.

12. The control method of the image forming apparatus according to claim 10, wherein the switching power source includes a transformer to convert a switched signal into one or plural kinds of voltages, and
the switching frequency lower than that in the normal operation mode is the switching frequency reduced to an extent that the transformer does not cause magnetic saturation.

13. The control method of the image forming apparatus according to claim 10, wherein the plural power saving modes include a standby mode in which power necessary at a time of printing is reduced by turning off a motor clutch, and a sleep mode in which all power is turned off except for power necessary for communication with outside,
the plural switching power sources include a first switching power source and a second switching power source,
at the step (b),
in the standby mode, the first switching power source keeps the switching frequency in the normal operation mode, whereas the second switching power source makes a change to a switching frequency lower than the switching frequency in the normal operation mode, and
in the sleep mode, the first switching power source makes a change to a switching frequency lower than the switching frequency in the normal operation mode, and the second switching power source turns off its output.

14. The control method of the image forming apparatus according to claim 13, wherein the first switching power source is the power source to supply power to be supplied to a control unit and the power necessary for communication with the outside, and
the second switching power source is the power source to supply power of a motor to drive each unit at the time of printing.
